(19) United States
(12) Patent Application Publication
(10) Pub. No.: US 2008/0303783 A1
(43) Pub. Date: Dec. 11, 2008

(54) Touchless detection display

(76) Inventor: Karl S. Weibezahn, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/810,718

(22) Filed: Jun. 7, 2007

(51) Int. Cl. G09G 5/00

(52) U.S. Cl. 345/156

(57) ABSTRACT

A touchless detection display includes a transparent display, a display face, a light detector and light control material. The transparent display displays information to a viewer. The viewer views the information through the display face. The light detector detects incoming light that travels into the touchless detection display through the display face. The light control material receives incoming light that travels into the touchless detection display through the display face before the incoming light reaches the light detector. The light control material prevents portions of the incoming light that are not traveling substantially perpendicular to the display face from reaching the light detector. Locations of objects close to but not touching the display face are detected by the touchless detection display based on the incoming light detected by the light detector.

### BACKGROUND

Touchscreen displays are ubiquitous worldwide. Touchscreens are integrated in many computer displays, automated teller machine (ATM) displays, personal digital assistant (PDA) displays, phone displays, stereo equipment displays, camera displays and so on. A touchscreen display allows a user to input information by touching locations on a display with a pointing device such as a stylus or finger.

Frequent touching a touchscreen display with a pointing device such as a finger can result in the gradual de-sensitization of the touchscreen to input and can ultimately lead to failure of the touchscreen. This occurs, for example, due to the high point stresses imparted by a user on flexible protective and functional layers of the touchscreen.

In additional to functional deterioration resulting from use of a touchscreen display, frequent touching can also result in aesthetic degradation. This can occur, for example, from scratches caused by a stylus or fingernail. Aesthetic degradation can also result from smudges from things like skin oil, food and topical lotions. The functional and aesthetic deterioration of a touchscreen display can result in a need for repair or replacement of the touchscreen display.

Touchscreen displays can also provide an opportunity for pathogen transfer when the touchscreen is part of a display available for use in a public place. For example, touchscreen displays can be included in ATMs and information kiosks that are available for use by the general public. It is desirable to alleviate concerns for pathogenic transfers as well as to limit functional and aesthetic deterioration of touchscreen displays.

### BRIEF DESCRIPTION OF THE DRAWINGS

FIG. 1 is a top down cross-sectional view illustrating implementation of a touchless detection display in accordance with an embodiment of the present invention.

FIG. 2 is a simplified block diagram illustrating implementation of a touchless detection display in accordance with another embodiment of the present invention.

### DESCRIPTION OF THE EMBODIMENTS

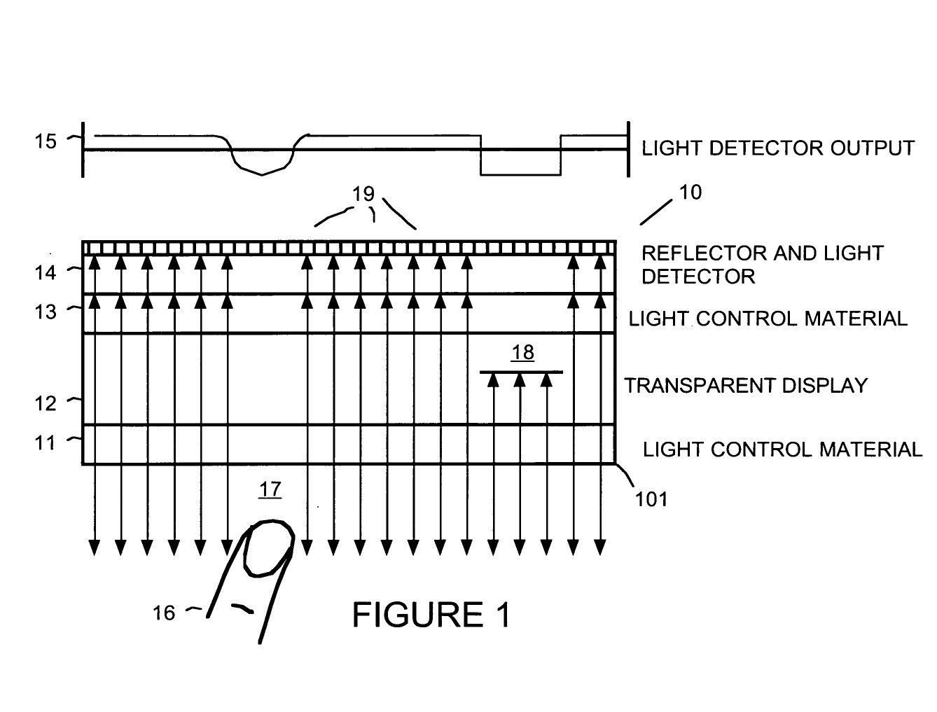

FIG. 1 is a top down cross-sectional not to scale view illustrating implementation of a touchless detection display 10. Light control material 11 receives ambient light that passes through a transparent display 12 and light control material 13 to reach a reflector and light detector 14. Most of the light is reflected from reflector and light detector 14 and returns through light control material 13, transparent display 12 and light control material 11.

The reflected light allows a user to read information displayed by transparent display 12. Transparent display 12 may be implemented, for example, as a liquid crystal display or alternatively by any other type of transparent display, using, for example, rigid or non-rigid components. What is meant by a transparent display is a display that allows at least some light to pass through the display.

Some of the light that reaches reflector and light detector 14 is absorbed by reflector and light detector 14 and used by an array of photodetectors 19 within reflector and light detector 14 to provide a light detector output signal, as illustrated by a graph 15 of the light detector output signal. Array of photodetectors 19 is, for example, a two dimensional array of photodetectors with an array density (e.g., pixels per inch in two dimensions) that does not necessarily match the array density of display 12, but can be optimized dependent on intended use of the touchless detection display 10. For example, touchless detection display 10 can be integrated into a computer display, an ATM display, a personal digital assistant display, a phone display, a camera display or a display for some other type of electronic device. Different uses can require different array densities for array of photodetectors 19.

Light control material 11 serves to block out at least a portion of light that is not substantially perpendicular to a display face 101 of touchless detection display 10. Display face 101 can include, for example, protective coatings that protect display face 101 from the elements or objects that come into contact with display face 101.

Light control material 11 is implemented, for example by a light control film, such as Vikuiti Advanced Light Control Film available from 3M Corporation. Alternatively, light control material 11 is implemented using another type of film or layer of material that acts as microlouvers of light or in some way louvers light that passes through light control material 11. What is meant by louvering light is to remove at least a portion of light that is not moving parallel to a predetermined direction.

In many embodiments of the present invention, a single layer of light control material is sufficient. For example, in many implementations light control material 11 alone will block out a sufficient enough portion of light that is not substantially perpendicular to display face 101 of touchless detection display 10 so that the location of an object located in front of display face 101 of touchless detection display 10 can be detected by variations in the signal strength of the output signal from array of photodetectors 19. In such implementations, light control material 13 is not needed so can be omitted from touchless detection display 10. Light control material 13 is useful for implementations where light control material 11 does not block out a sufficient enough portion of light that is not substantially perpendicular to display face 101 of touchless detection display 10 so that the location of an object located in front of display face 101 of touchless detection display 10 can be detected by variations in the signal strength of the output signal from array of photodetectors 19.

When an object, such as a finger 16, is placed in front of display face 101 of touchless detection display 10, a shadow area 17 is formed. Shadow area 17 extends through touchless detection display 10 so that the corresponding photodetectors behind shadow area 17 detect less ambient light than at other locations in array of photodetectors 19. This is illustrated by a dip in the light detector output signal on graph 15 shown in FIG. 1. This dip in the light detector output signal is used by touchless detection display 10 to determine the location of the object in front of display face 101 of touchless detection display 10.

Transparent display 12 may include one or more closed pixel regions 18 that block ambient light from reaching array of photodetectors 19. Such pixel regions 18 are known by touchless detection display 10 so that the resulting dip in the light detector output signal will not be mistaken for an object in front of display face 101 of touchless detection display 10.

While touchless detection display 10 is able to detect input from an object touching display face 101 of touchless detection display 10, such touching is not necessary. When an object is close enough to generate a shadow region 17 in front of display face 101 of touchless detection display 10, the location of the object can be detected by touchless detection display 10.

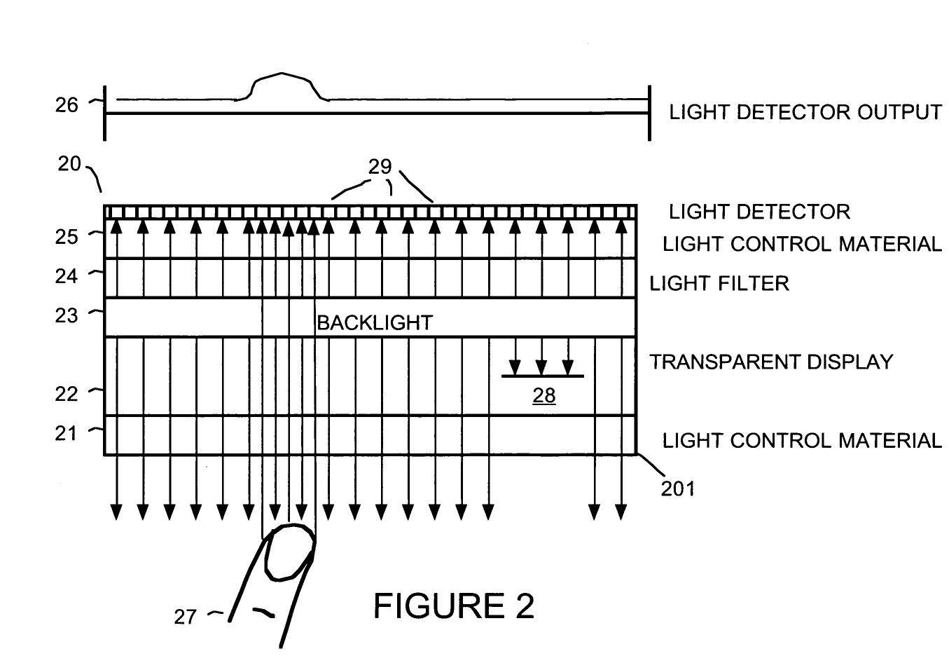

FIG. 2 is a top down cross-sectional not to scale view illustrating another implementation of a touchless detection display 20. A backlight 23 provides backlighting for an LCD display 22. A light control material 21 serves to block out light that is not substantially perpendicular to a display face 201 of touchless detection display 20. Light control material 21 is implemented, for example by a light control film such as one that acts as microlouvers of light or in some way louvers or collimates light that passes through light control material 21. Backlight 23 also provides lighting that travels back through a light filter 24 and light control material 25 to a light detector composed of, for example, an array of photodetectors 29.

When an object, such as a finger 27, is placed in front of a display face 201 of touchless detection display 20, light from backlight 23 is reflected back through light control material 21, transparent display 22, backlight 23, light filter 24 and light control material 25 to reach light detectors 29.

The light that reaches light detectors 29 is absorbed and used to provide a light detector output signal, as illustrated by a graph 26 of the light detector output signal. The additional light reflected by finger 27 provides an increase in the light detected by corresponding photodetectors behind finger 27 as compared with others of the array of photodetectors 29. This is illustrated by a rise in the light detector output signal on graph 26 shown in FIG. 2. This rise in the light detector output signal is used by touchless detection display 20 to determine the location of an object in front of display face 201 of touchless detection display 20.

Transparent display 22 may include one or more closed pixel regions 28 that light from backlight 23 from exiting transparent display 22. Typically this light is absorbed by transparent display 22 and not reflected back to array of photodetectors 29. Such pixel regions 28 should therefore have little or no impact on the photodetector output signal.

While touchless detection display 20 is able to detect input from an object touching display face 201 of touchless detection display 20, such touching is not necessary. When an object is close enough to generate reflected light back to touchless detection display 20, the location of the object can be detected by touchless detection display 20.

For many implementations, light control material 21 will block out a sufficient enough portion of light that is not substantially perpendicular to display face 201 of touchless detection display 20 so that the location of an object located in front of display face 201 of touchless detection display 20 can be detected by variations in the signal strength of the output signal from array of photodetectors 29. In such implementations, light control material 23 is not needed and so can be omitted from touchless detection display 20. Light control material 25 is useful for implementations where light control material 21 does not block out a sufficient enough portion of light that is not substantially perpendicular to display face 201 of touchless detection display 20 so that the location of an object located in front of display face 201 of touchless detection display 20 can be detected by variations in the signal strength of the output signal from array of photodetectors 29.

Light filter 24 is used to limit the wavelength of light that reaches light detectors 29. For example, light filter 24 filters out all light that has a wavelength less than 600 nanometers. This limits the amount of non-infrared light reaching array of photodetectors 29 and allows better detection of objects in front of display face 201 of touchless detection display 20 when photodetectors within array of photodetectors 29 are selected for sensitivity to infrared light. Because human skin reflects infrared light better than visible light, using a light filter that passes infrared light is desirable for many applications. However, bands of light other than infrared may be more optimal for particular applications and in such cases can be used for detection of objects in front of display face 201 of touchless detection display 20. In such applications, a light filter can be used that passes light with the desired wavelengths and photodetectors to detect and measure the same.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A touchless detection display, comprising:
a transparent display that displays information to a viewer;
a display face through which the viewer views the information;
a light detector that detects incoming light that travels into the touchless detection display through the display face; and,
light control material that receives incoming light that travels into the touchless detection display through the display face before the incoming light reaches the light detector, the light control material preventing portions of the incoming light that are not traveling substantially perpendicular to the display face from reaching the light detector;
wherein locations of objects close to but not touching the display face are detected by the touchless detection display based on the incoming light detected by the light detector.

2. A touchless detection display as in claim 1 wherein the transparent display is a liquid crystal display.

3. A touchless detection display as in claim 1 wherein the light detector comprises an array of photodetectors.

4. A touchless detection display as in claim 1 wherein the light control material is a light control film that acts as microlouvers of light.

5. A touchless detection display as in claim 1 wherein the light control material is arranged in a single layer that is adjacent to the display face.

6. A touchless detection display as in claim 1 wherein the light control material is arranged in multiple layers with a first layer that is adjacent to the display face and a second layer that is located between the light detector and the transparent display.

7. A touchless detection display as in claim 1 wherein the light detector comprises a reflector and an array of photodetectors, the reflector reflecting ambient light that enters the touchless detection display through the display face, the reflected ambient light providing lighting for the transparent display.

8. A touchless detection display as in claim 1, additionally comprising:
a backlighting source located between the transparent display and the light detector;
wherein the light detector detects an increase in incoming light at locations where light from the backlighting source is reflected by objects close to, but not touching, the display face.

9. A touchless detection display as in claim 1, additionally comprising:
a backlighting source located between the transparent display and the light detector; and,
a light filter, located between the backlighting source and the light detector, the light filter filtering out light that does not have a wavelength within a predetermined range;
wherein the light detector detects an increase in incoming light at locations where light from the backlighting source is reflected by objects close to, but not touching, the display face.

10. A touchless detection display as in claim 1, additionally comprising:
a backlighting source located between the transparent display and the light detector; and,
a light filter, located between the backlighting source and the light detector, the light filter filtering out light is not infrared light;
wherein the light detector detects an increase in incoming light at locations where light from the backlighting source is reflected by objects close to, but not touching, the display face.

11. A method for detecting user input by a touchless detection display, the method comprising:
displaying information to a viewer by the touchless detection display; and,
receiving an input selection from the user without the user touching the display, including the following:
receiving incoming light that travels into the touchless detection display through the display face and producing louvered light by removing from the incoming light portions of the incoming light that are not traveling substantially perpendicular to the display face, and
detecting by the touchless detection display, intensity of the louvered light based on locations at which the louvered light initially entered the display face in order to determine locations of objects close to but not touching the display face.

12. A method as in claim 11 wherein the louvered light is produced by a light control material that is arranged in a single layer that is adjacent to the display face.

13. A method as in claim 11 wherein a location of an object close to but not touching the display is indicated by a reduction in detected light intensity caused by the object blocking ambient light from entering the display face near the location of the object.

14. A method as in claim 11 wherein a location of an object close to but not touching the display face is indicated by an increase in detected light intensity caused by the object reflecting light originating from backlighting within the touchless detection display.

15. A method for providing a display with the ability to receive touchless input from a user, comprising:
placing light control material between a display face and a transparent display that displays information to the user; and
placing behind the transparent display a light detector that detects incoming light that travels into the touchless detection display through the display face;
wherein the light control material is arranged to receive incoming light that travels into the touchless detection display, the light control material preventing portions of the incoming light that are not traveling substantially perpendicular to the display face from reaching the light detector; and
wherein the touchless detection display is enabled to detect locations of objects close to but not touching the display face by the touchless detection display based on the incoming light detected by the light detector.

16. A method as in claim 15 additionally comprising:
placing additional light control material between the light detector and the transparent display.

17. A method as in claim 15 additionally comprising:
including within the light detector a reflector, the reflector reflecting ambient light that enters the touchless detection display through the display face so that the reflected ambient light provides lighting for the transparent display.

18. A method as in claim 15 additionally comprising:
placing a backlighting source between the transparent display and the light detector so that the light detector detects an increase in incoming light at locations where light from the backlighting source is reflected by objects close to, but not touching, the display face.

19. A method as in claim 15 additionally comprising:
placing a backlighting source between the transparent display and the light detector; and,
placing a light filter between the backlighting source and the light detector, the light filter filtering out light that does not have a wavelength within a predetermined range so that the light detector detects an increase in incoming light at locations where light from the backlighting source is reflected by objects close to, but not touching, the display face.

20. A touchless detection display, comprising:
means for displaying information to a viewer;
means for detecting incoming light that travels into the touchless detection display through the display face; and,
means for receiving incoming light that travels into the touchless detection display through the display face before the incoming light is detected by the means for detecting incoming light, and for preventing portions of the incoming light that are not traveling substantially perpendicular to a display face of the touchless detection display from being detected by the means for detecting incoming light;
wherein locations of objects close to but not touching the display face are detected by the touchless detection display based on the incoming light detected by the means for detecting incoming light.
